(19) United States
(12) Patent Application Publication
(10) Pub. No.: US 2025/0037046 A1
(43) Pub. Date: Jan. 30, 2025

(54) INFORMATION PROCESSING APPARATUS CHANGING PROVISION STATE OF SERVICE WHEN DETERMINING THAT PRESCRIBED CONDITION IS MET

(71) Applicant: BROTHER KOGYO KABUSHIKI KAISHA, Nagoya (JP)

(72) Inventors: Koichi TSUGIMURA, Nagoya (JP); Taichiro KIMOTO, Nagoya (JP); Yutaka TAKIJIRI, Nagoya (JP); Nobuyuki KAMIYA, Anjo (JP)

(21) Appl. No.: 18/779,520

(22) Filed: Jul. 22, 2024

(30) Foreign Application Priority Data
Jul. 28, 2023 (JP) 2023-123280

(51) Int. Cl. G06Q 10/063; G06Q 10/08

(52) U.S. Cl. CPC G06Q 10/063; G06Q 10/08

(57) ABSTRACT

An information processing apparatus includes a memory and a controller. The memory is for storing therein provision state information. The provision state information indicates a provision state of a service. The provision state is one of at least two states including a first state and a second state. In the first state, a new consumable is delivered to a user when a residual quantity of a consumable has dropped below a predetermined residual quantity. In the second state, procurement request information is outputted to the user when the residual quantity of the consumable has dropped below the predetermined residual quantity. The procurement request information requests the user to obtain a new consumable in a manner not reliant on delivery. The controller is configured to determine whether a prescribed condition for changing the provision state is met, and to change the provision state when determining that the prescribed condition is met.

### REFERENCE TO RELATED APPLICATIONS

This application claims priority from Japanese Patent Application No. 2023-123280 filed on Jul. 28, 2023. The entire content of the priority application is incorporated herein by reference.

### BACKGROUND ART

Conventionally known technologies enable a user to print a preset number of sheets at a flat rate every predetermined period during the term of the contract. The manufacturer with which the user has entered into the contract delivers consumables to the user so that the user can obtain consumables without having to go somewhere to purchase them.

### SUMMARY

Even when a service contract in which a manufacturer is to deliver consumables to a user is in effect therebetween, as described in the conventional technologies, certain circumstances may make it more convenient for the user or the manufacturer to have the user obtain consumables in a manner other than by delivery. However, no specific consideration is given for such circumstances in the conventional technologies.

In view of the foregoing, it is an object of the present disclosure to provide an information processing apparatus that can improve convenience for the user or the manufacturer by enabling the user to obtain a consumable in a manner other than delivery, even when a contract for the delivery of consumables to the user is in effect.

In order to attain the above and other objects, the present disclosure provides an information processing apparatus for managing a contract for a service to provide a consumable to a user. The information processing apparatus includes a memory and a controller. The memory is for storing therein provision state information indicating a provision state of the service. The provision state is one of at least two states including a first state and a second state. In the first state, a new consumable is delivered to the user when a residual quantity of a consumable in use under the service has dropped below a predetermined residual quantity. In the second state, procurement request information is outputted to the user when the residual quantity of the consumable in use under the service has dropped below the predetermined residual quantity. The procurement request information requests the user to obtain a new consumable in a manner not reliant on delivery. The controller is configured to perform determining whether a prescribed condition for changing the provision state is met. The controller is configured to further perform changing the provision state when determining that the prescribed condition is met.

In the above configuration, the controller determines whether the prescribed condition for changing the provision state is met, and changes the provision state when determining the prescribed condition is met. This configuration enables the provision state to be changed to a state convenient for the user or manufacturer. Therefore, the user can obtain a consumable in a manner not reliant on delivery even in a state where a contract for consumables to be delivered to the user is in effect, thereby improving convenience for the user or manufacturer.

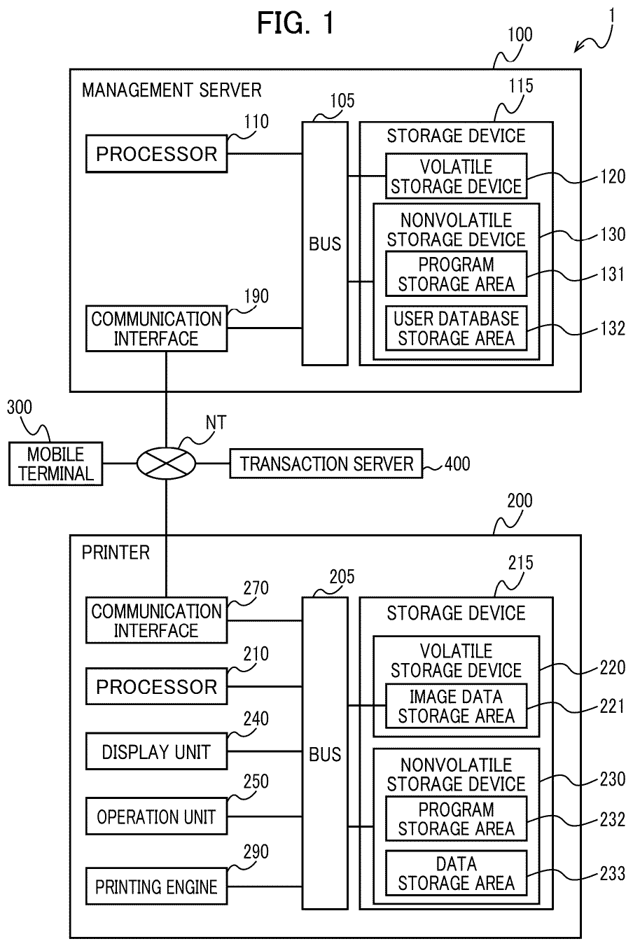

FIG. 1 is a block diagram illustrating an example system configuration of a printing service provision system.

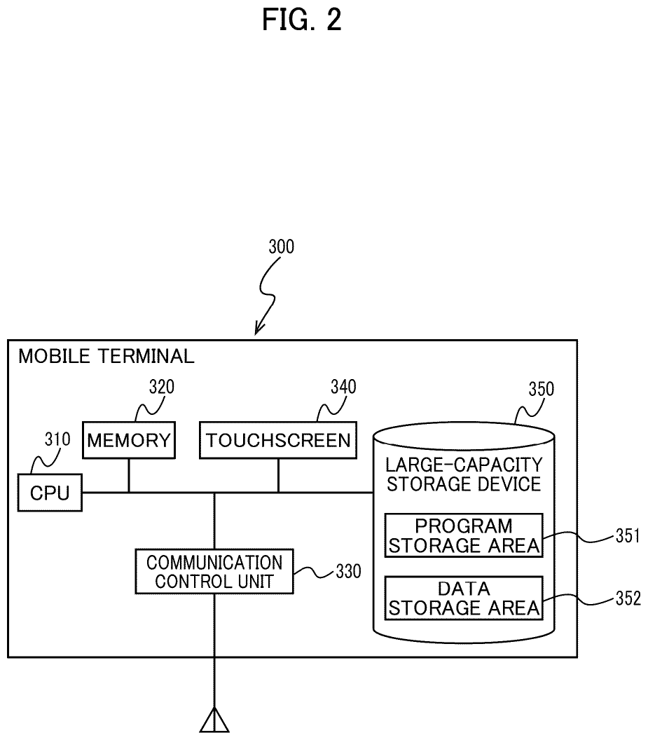

FIG. 2 is a block diagram illustrating an example system configuration of a mobile terminal.

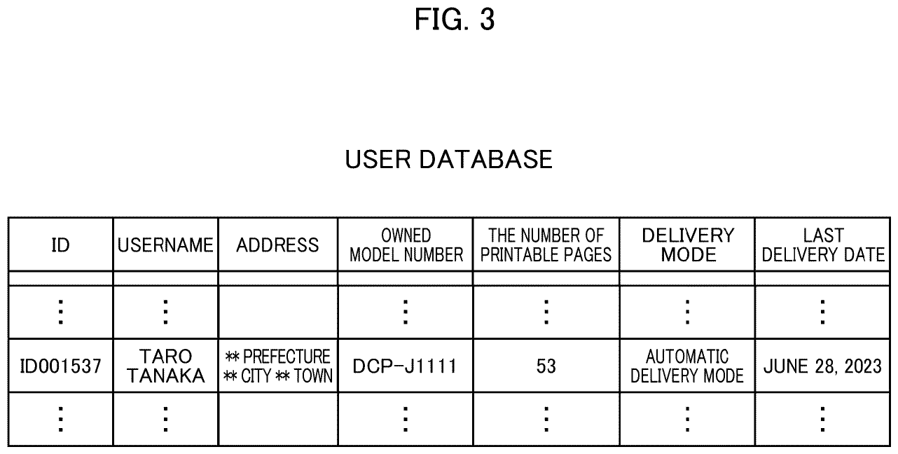

FIG. 3 is a schematic diagram illustrating an example of a user database.

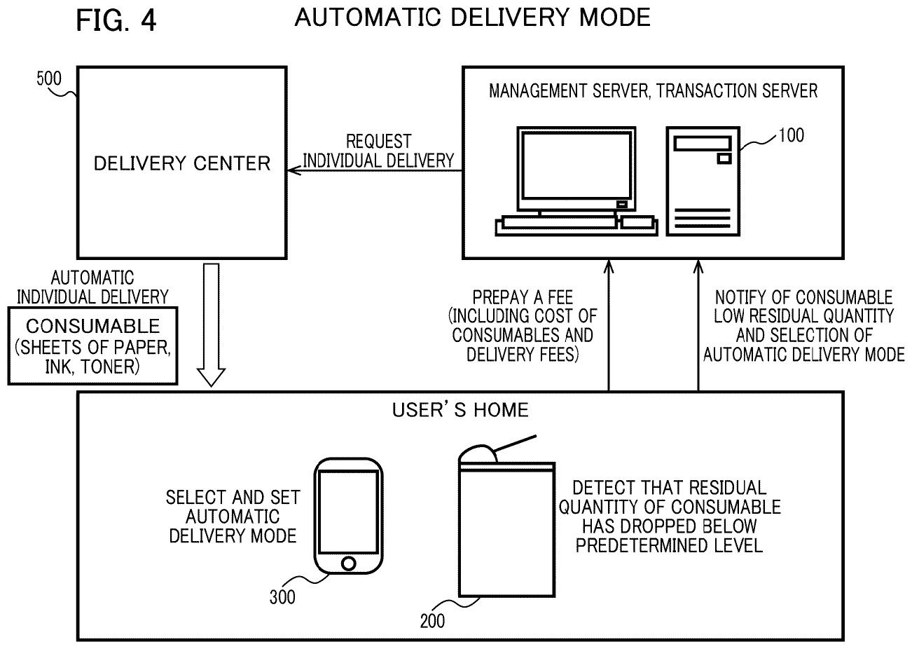

FIG. 4 is a schematic diagram illustrating a process flow when an automatic delivery mode is selected and executed.

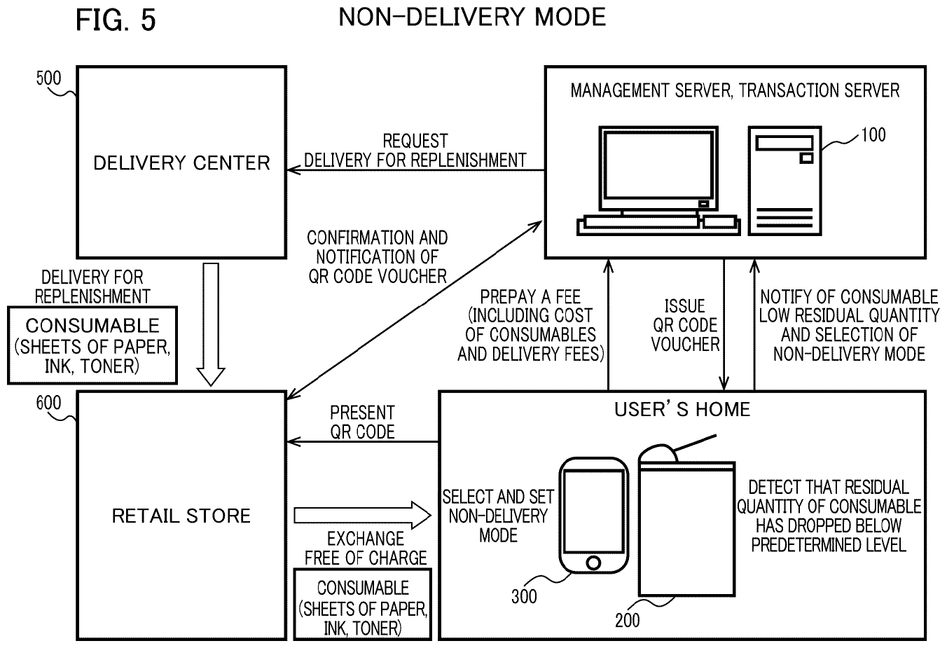

FIG. 5 is a schematic diagram illustrating a process flow when a non-delivery mode is selected and executed.

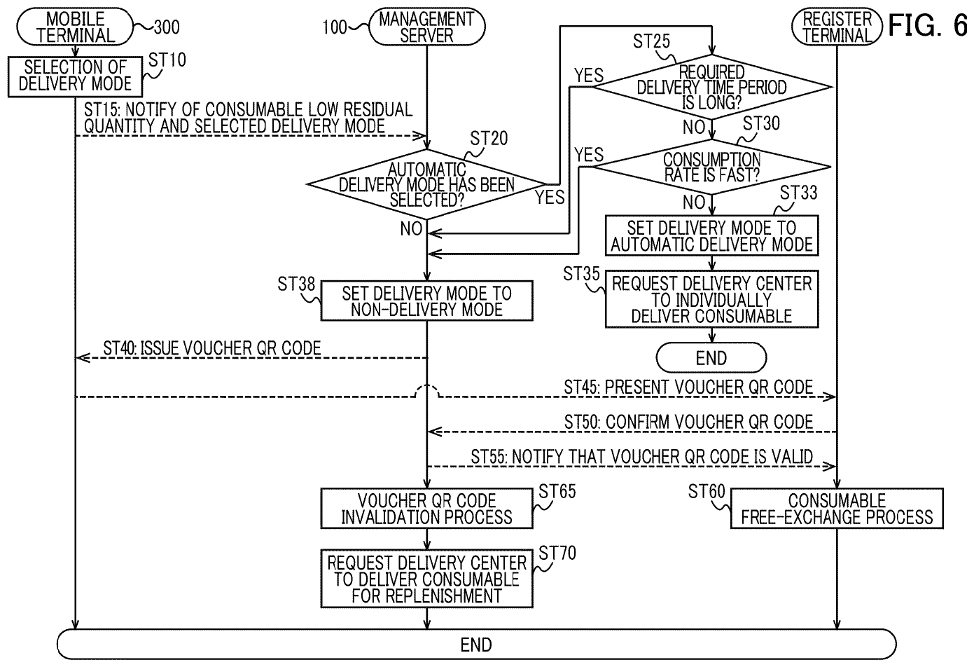

FIG. 6 is a sequence chart illustrating example steps in a process executed when a residual quantity of a consumable becomes low.

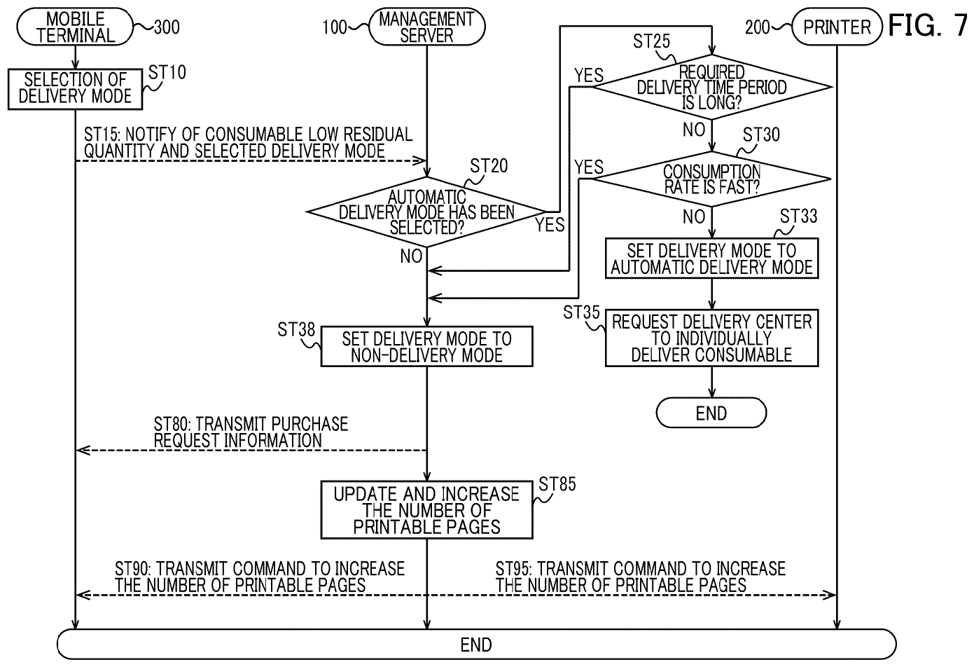

FIG. 7 is a sequence chart illustrating example steps in a process executed when a residual quantity of a consumable becomes low in a configuration in which a profit equivalent to a purchase cost and a delivery cost for a consumable is returned to a user.

### DESCRIPTION

An embodiment of the present disclosure will be described while referring to the accompanying drawings.

### <Overall Configuration of a Printing Service Provision System>

FIG. 1 shows an example system configuration of a printing service provision system 1 according to one embodiment of the present disclosure. The printing service provision system 1 of this embodiment provides a prepaid printing service in which users (i.e., customers) pay a fee in advance to use the printing functions of a printer 200. As shown in FIG. 1, the printing service provision system 1 includes a management server 100, a printer 200, a mobile terminal 300, and a transaction server 400. The management server 100, printer 200, mobile terminal 300, and transaction server 400 are connected to a network NT and can communicate with each other. The network NT includes cell phone communication lines. The management server 100 is an example of the information processing apparatus. The printer 200 is an example of the printing apparatus and is also an example of the prescribed process apparatus.

### <Management Server>

The management server 100 is a server that is installed and managed by the manufacturer of the printer 200, for example. As shown in FIG. 1, the management server 100 includes a processor 110, a storage device 115, and a communication interface 190. The processor 110, storage device 115, and communication interface 190 are interconnected via a bus 105 and can exchange data with one another.

The storage device 115 includes a volatile storage device 120, and a nonvolatile storage device 130. The volatile storage device 120 is DRAM, for example, and stores various programs and data to be used for processing. The nonvolatile storage device 130 is a hard disk drive or a solid-state drive, for example. The nonvolatile storage device 130 has a program storage area 131, and a user database storage area 132.

The program storage area 131 stores therein various programs. The programs include a program related to switching the delivery mode based on the sequence chart in FIG. 6 and the like described later, and the various processes that need to be performed in conjunction with this switching process. The user database storage area 132 stores various information on users who have entered into a contract for the prepaid printing service. This user database will be described later in greater detail with reference to FIG. 3.

The processor 110 is a device such as a CPU that performs data processing. The processor 110 executes various programs stored in the program storage area 131, including the program related to switching the delivery mode and other necessary processes. The processor 110 performs various processes including a process to perform data communications with the mobile terminal 300, printer 200, and transaction server 400 connected to the network NT. The processor 110 also performs a process to purchase printing authorization in the printing service provision system 1 according to the present embodiment. The nonvolatile storage device 130 is an example of the memory. The processor 110 is an example of the controller.

The communication interface 190 is a wired LAN interface or a wireless interface for communicating with other devices. The communication interface 190 is connected to the network NT.

The storage device 115 is not limited to the component configuration described above. For example, the storage device 115 may be configured of RAM, ROM, EEPROM, a hard disk drive, a portable storage medium such as USB memory detachably mounted in the management server 100, a buffer provided in the processor 110, or any combination thereof.

The storage device 115 may be a computer-readable storage medium. A computer-readable storage medium is a non-transitory medium. In addition to the above examples, non-transitory media include storage media such as CD-ROM and DVD-ROM. A non-transitory medium is also a tangible medium. This also applies to a storage device 215 of the printer 200 described later.

### <Printer>

The printer 200 is owned by a user receiving the prepaid printing service provided through the printing service provision system 1, for example. As shown in FIG. 1, the printer 200 includes a processor 210, a storage device 215, a display 240, an operation unit 250, a communication interface 270, and a printing engine 290. The processor 210, storage device 215, display 240, operation unit 250, communication interface 270, and printing engine 290 are interconnected via a bus 205 and can exchange data with one another.

The storage device 215 includes a volatile storage device 220, and a nonvolatile storage device 230. The volatile storage device 220 is DRAM, for example. The volatile storage device 220 has an image data storage area 221 for storing image data to be printed. The nonvolatile storage device 230 is flash memory, for example. The nonvolatile storage device 230 has a program storage area 232, and a data storage area 233. The program storage area 232 stores therein various programs as firmware, for example. The data storage area 233 stores the number of printable pages, a printer ID for identifying the printer 200, and the like.

The processor 210 is a device such as a CPU that performs data processing. The processor 210 executes the various programs stored in the program storage area 232.

The display 240 can display various information. The display 240 is a liquid crystal display, for example. The operation unit 250 is a device configured to receive user operations. By operating the operation unit 250, the user can input various instructions into the printer 200. The communication interface 270 is a wired or wireless network interface for communicating with other devices. The communication interface 270 is connected to the network NT.

The printing engine 290 feeds sheets of paper from a paper tray and conveys the sheets with a conveying mechanism (not shown) while printing images on the conveyed sheets according to a prescribed method. While there are no particular restrictions on the type of printing method, printing may be performed according to the inkjet method or laser method, for example. While not illustrated in the drawings, the printing engine 290 forms images on sheets of paper using ink from ink cartridges or toner from toner cartridges based on a print job received from the mobile terminal 300 or based on a print job generated by the printer 200 itself in response to operations on the operation unit 250.

### <Mobile Terminal>

FIG. 2 shows an example system configuration of the mobile terminal 300. The mobile terminal 300 is a portable terminal owned by the user, such as a smartphone. The mobile terminal 300 is configured to be connected to the network NT through wireless communication. As shown in FIG. 2, the mobile terminal 300 includes a CPU 310, a memory 320, a communication control unit 330 for connecting the mobile terminal 300 to the network NT through wireless communication, a touchscreen 340, and a large-capacity storage device 350.

The large-capacity storage device 350 is flash memory, for example. The large-capacity storage device 350 has a program storage area 351, and a data storage area 352. The program storage area 351 stores therein various programs, for example as applications. The CPU 310 executes the various programs stored in the program storage area 351. The CPU 310 executes various processes including a process to perform data communications with the management server 100 connected to the network NT. The data storage area 352 stores therein information such as a user ID for identifying the user corresponding to the mobile terminal 300. The user ID is issued based on the above programs or the printing service described above.

The touchscreen 340 of the mobile terminal 300 is an integral combination of a liquid crystal display and a touch pad. The touchscreen 340 displays various information and receives various user operations. By operating the touchscreen 340, the user can input various instructions into the mobile terminal 300.

In place of the portable terminal described above, a tablet computer, desktop computer, or other information terminal may be used as the mobile terminal 300.

### <Transaction Server>

The transaction server 400 shown in FIG. 1 is a server for settling online payments over the network NT. While not shown in the drawings, the transaction server 400 includes a processor, a storage device, and a communication interface for connecting the transaction server 400 to the network NT.

### <User Database>

FIG. 3 schematically illustrates some content of the user database related to the prepaid printing service. The user database is stored in the user database storage area 132 of the nonvolatile storage device 130 in the management server 100. The user database stores records therein information on users who have entered into a contract for receiving the prepaid printing service of the printing service provision system 1. The user database in the example of FIG. 3 records therein an ID for each user, which is identification information for uniquely identifying that user. The user database further records therein, in association with each ID: the username of the user identified by that ID; an owned model number, which is model number information specifying the printer 200 owned by this user; the number of printable pages remaining for the printer 200 at this time; the delivery mode (i.e., delivery mode information indicating the delivery mode); and the last delivery date. The delivery mode and the last delivery date will be described later.

### <Prepaid Printing Service>

In the printing service provision system 1 according to the present embodiment, the management server 100, printer 200, mobile terminal 300, and transaction server 400 are connected and can exchange information with each other over the network NT. The management server 100 centrally manages procedures for purchasing printable pages (described later), which are performed on the mobile terminal 300 of a given user for the printer 200 owned by the same user, and the status of increases and decreases in the number of printable pages for that printer 200.

The printing service provided in the printing service provision system 1 of the present embodiment is a prepaid printing service. In this prepaid printing service, the user pre-purchases a printing authorization that guarantees a corresponding number of printable pages (i.e., a corresponding number of printing credits), the corresponding number of printable pages is added to the current number of printable pages for the target printer 200, and the user can print on the printer 200 up to the resultant number of printable pages (i.e., the sum of the current number of printable pages and the newly purchased printable pages). For example, the processor 110 of the management server 100 adds the purchased number of printable pages to the current number of printable sheets (i.e., increases the number of printable sheets by the purchased number of printable pages). The processor 100 transmits the calculated number of printable pages (i.e., the increased number of printable pages) to the printer 200 at regular intervals, for example. The number of printable pages is stored in the user database storage area 132 of the nonvolatile storage device 130 on the management server 100 and in the data storage area 233 of the nonvolatile storage device 230 on the printer 200, for example. Each time a print is performed, the number of printable pages is reduced by the number of printed pages. For example, the processor 210 of the printer 200 reduces the number of printable pages after a print and transmits the new number of printable pages (i.e., the reduced number of printable pages) to the management server 100 at regular intervals. The number of printable pages is an example of the printable quantity.

The printing service provision system 1 of the present embodiment offers, as a form of purchasing printing authorization, a method of purchasing printing authorization based on the user's purchase request. In this method, the user performs a prescribed operation on the mobile terminal 300 to transmit an application to purchase a printing authorization from the mobile terminal 300 to the management server 100, and when the management server 100 accepts the application, this purchase of the printing authorization is performed. Note that the user can purchase a printing authorization according to this method at any desired timing. In this method, the user selects one printable page addition plan from among a plurality of printable page addition plans having different numbers of printable pages and different purchase prices and purchases a printing authorization corresponding to the selected printable page addition plan. For example, the printable page addition plans may include 50 printable pages for 500 yen, 100printable pages for 900 yen, and 250 printable pages for 2,000 yen.

A key point of the business model for such a prepaid printing service is that the only fee a user must pay for the service is the purchase price of the printing authorization, and no other payments are required. Hence, in the prepaid printing service according to the present embodiment, when consumables in the printer 200, such as paper, ink, or toner, become low and need to be replenished or replaced due to printing using the printer 200, either service personnel comes directly to replenish or replace those consumables, or the consumables are delivered through a delivery service and the user replenishes or replaces the consumables themselves. However, the prepaid printing service according to the present embodiment does not incur any additional cost to the user when replenishing or replacing consumables since the purchase prices of the replenished or replacement consumables themselves and the delivery and handling fees are already included in the purchase price of printing authorization.

### <Features of the Embodiment>

In the prepaid printing service described above, when consumables in a printer become low, new consumables are automatically delivered to the user's home or other location. This can eliminate the need for users to physically purchase consumables themselves and, hence, is highly convenient for the users. However, some users may wish to avoid registering their personal information required for this service, such as their address, and may instead prefer to go to the nearest retail store, purchase the consumables, and replenish or replace the depleted consumables themselves. Users who are in a hurry to print may also wish to purchase the consumables themselves in order to continue printing immediately without having to wait for the consumables to be brought by the delivery service or service personnel.

In view of the foregoing, in the printing service provision system 1 according to the present embodiment, the user can select between an automatic delivery mode in which new consumables are automatically delivered to the user when the residual quantity of the consumable falls below a predetermined residual quantity, and a non-delivery mode in which procurement request information is outputted to the user requesting the user to obtain new consumables in a manner not reliant on delivery.

Moreover, upon purchasing printing authorization, the user has already paid an amount equivalent to the cost of the consumables for the user's own consumption and the delivery fees, as described above. Therefore, if the user had to purchase new consumables by paying the fee for the new consumables in the non-delivery mode, the user would be doubly burdened. For this reason, the management server 100 in the present embodiment issues the user a voucher with which the user can obtain consumables at no cost when the non-delivery mode has been selected.

As described above, the present embodiment can improve convenience for the user or manufacturer by allowing the user to obtain a consumable in a manner not dependent on delivery, even in a state where a contract for consumables to be delivered to the user is in effect (i.e., a state where the user has entered into a contract for consumables to be delivered to the user).

### <Detailed Description of the Automatic Delivery Mode and the Non-delivery Mode>

FIG. 4 schematically illustrates the process flow in the printing service provision system 1 when the automatic delivery mode is selected and executed. FIG. 5 schematically illustrates the process flow in the printing service provision system 1 when the non-delivery mode is selected and executed. In both modes shown in FIGS. 4 and 5, the user first prepays a fee via the management server 100 and transaction server 400 (not shown in these drawings) in order to increase the number of printable pages for the printer 200 owned by the same user. As described above, the fee that the user prepays at this time includes the cost of consumables corresponding to the increase in the number of printable pages and the delivery fees for delivering those consumables.

When the residual quantity of a particular consumable, such as paper, ink, or toner, falls below the predetermined residual quantity as a result of printing operations performed on the printer 200, the printer 200 self-detects this and notifies the mobile terminal 300. Upon receiving such a notification, the mobile terminal 300 displays information on the touchscreen 340 indicating the low level of this consumable and receives input from a user operation selecting whether the user wishes to obtain the consumable in the automatic delivery mode or in the non-delivery mode. When the user has selected the automatic delivery mode, as illustrated in FIG. 4, the mobile terminal 300 transmits information indicating this selection to the management server 100 together with information indicating which consumable has become low.

Upon receiving this information, the management server 100 references the user database to obtain the corresponding username and address and sends a request to a delivery center 500, requesting the delivery center 500 to individually deliver the required consumable to the user at this address. The delivery center 500 then delivers the requested consumable to the address of the target user. Upon receiving the consumable, the user replenishes or replaces the consumable themselves to continue printing.

On the other hand, when the user has selected the non-delivery mode on the mobile terminal 300, as illustrated in the example of FIG. 5, the mobile terminal 300 transmits information indicating this selection to the management server 100 together with information indicating which consumable has become low. Upon receiving this information, the management server 100 issues a new and uniquely generated voucher QR code and sends display information to the mobile terminal 300 for displaying this QR code and for requesting that the user obtain the consumable themselves. Note that “QR code” is a Japanese registered trademark of DENSO WAVE INCORPORATED. The user goes to the nearest retail store 600 and presents the voucher QR code displayed on the mobile terminal 300. An employee at the retail store 600 reads the voucher QR code at a register terminal (not shown) and transmits information read from this QR code to the management server 100 to confirm its validity. The voucher QR code is an example of the procurement request information. The display on the terminal device 300 of the request requesting the user to obtain the consumable themselves is an example of the purchase request notification.

When the validity of the QR code is confirmed on the management server 100 side and the register terminal at the retail store 600 receives a notification to that effect, the retailer provides the consumable to the user free of charge. The user can then continue printing after replenishing or replacing the consumable themselves. In this way, the user does not have to pay for the consumable, thereby avoiding a double payment. Once the voucher QR code has been used, the management server 100 invalidates the used voucher QR code, thereby suppressing the free-exchange from being performed multiple times using the same voucher QR code. The management server 100 subsequently issues a request to the delivery center 500, requesting the delivery center 500 to restock the retail store 600 with the consumable. Then, the delivery center 500 delivers the consumable to the retail store 600.

While the above automatic delivery mode requires that the user has already registered the user's address in the user database, the non-delivery mode can be utilized without registering an address. In the above description, the user is prompted to select a delivery mode each time the residual quantity of a consumable falls below the predetermined residual quantity, but the user may select a desired delivery mode in advance and set this delivery mode as a default setting or a fixed setting in the user database on the management server 100. The mobile terminal 300 may also confirm whether this default setting or fixed setting is still appropriate each time the residual quantity of a consumable falls below the predetermined residual quantity.

When the required delivery time period, i.e., the time period required for delivering the consumable is predicted to be long due to the user's address registered in the user database being far from the delivery center 500, the delivery mode is forcibly set to the non-delivery mode, irrespective of the user's selection. Additionally, when the consumable is found to have reached a low level within a short time since the last delivery date registered in the user database, it is predicted that the new consumable cannot be delivered before the current consumable is completely depleted because a recent high frequency of printing results in a high rate of consumption of the consumable. As a remedy, in this embodiment, the delivery mode is forcibly set to the non-delivery mode without regard for the user's selection and the user is requested to obtain the necessary consumable as soon as possible. For this purpose, last delivery dates must be registered in the user database by type of consumable.

The automatic delivery mode is an example of the first state. The non-delivery mode is an example of the second state. The delivery mode is an example of the provision state. The user's selection, the required delivery time period, and the consumption rate are each an example of the prescribed condition.

### <Processing Sequence When a Consumable Becomes Low>

Next, the sequence of processes performed on devices in the printing service provision system 1 according to the present embodiment when a consumable becomes low will be described with reference to FIG. 6. This processing sequence begins when the printer 200 detects that the residual quantity of a particular consumable has dropped below the predetermined residual quantity.

In ST10 the mobile terminal 300 displays information on the touchscreen 340 indicating what consumable has a residual quantity less than or equal to the predetermined residual quantity and receives a user operation to select a desired delivery mode in which the user wishes to obtain this consumable. In ST15 the mobile terminal 300 transmits to the management server 100 a notification including: consumable low residual quantity information indicating the residual quantity of the consumable is low; and information indicating the selected delivery mode.

Upon receiving this notification, in ST20 the processor 110 of the management server 100 determines whether the selected delivery mode is the automatic delivery mode. The processor 110 of the management server 100 advances to ST25 when determining that the selected delivery mode is the automatic delivery mode, i.e., that the automatic delivery mode has been selected (ST20: YES). In ST25 the processor 110 of the management server 100 references the user address in the user database and compares this address to the address of the delivery center 500 to determine whether the required delivery time period is equal to or longer than a prescribed time period. When the required delivery time period is sufficiently short, i.e., the required delivery time period is shorter than the prescribed time period (ST25: NO), in ST30 the processor 110 of the management server 100 references the last delivery date in the user database and compares this date to the current date to determine whether the consumption rate of the consumable (i.e., the rate at which the consumable is consumed) is equal to or faster than a prescribed rate. When the consumption rate is sufficiently slow, i.e., the consumption rate of the consumable is slower than the prescribed rate (ST30: NO), the processor 110 of the management server 100 advances to ST33.

In ST33 the processor 110 of the management server 100 internally sets the delivery mode to the automatic delivery mode and sets related parameters to values for the automatic delivery mode. At this time, in the user database, the processor 110 updates the delivery mode information associated with both the current user and the target consumable. More specifically, when the delivery mode information indicates that the delivery mode is the non-delivery mode, in ST33 the processor 110 updates the delivery mode information so that the delivery mode information indicates that the delivery mode is the automatic delivery mode (i.e., in ST33 the processor 110 changes the delivery mode from the non-delivery mode to the automatic delivery mode). However, when the delivery mode information indicates that the delivery mode is the automatic delivery mode, in ST33 the processor 110 retains the delivery mode information so that the delivery mode information continues to indicate that the delivery mode is the automatic delivery mode (i.e., in ST33 the processor 110 maintains the delivery mode in the automatic delivery mode). In ST35 the management server 100 executes the process according to the automatic delivery mode. That is, the processor 110 of the management server 100 references the user database and transmits a notification to the delivery center 500 requesting the delivery center 500 to individually deliver the target consumable to the user's address referenced in the user database. At this time, in the user database, the processor 110 of the management server 100 updates the last delivery date associated with both the current user and the target consumable. This completes the sequence of FIG. 6. The delivery mode information recorded in the user database is an example of the provision state information.

On the other hand, when the processor 110 of the management server 100 determines in ST20 that the selected delivery mode is the non-delivery mode, i.e., the non-delivery mode has been selected (ST20: NO) or when the processor 110 of the management server 100 determines in ST25 that the required delivery time period is equal to or longer than the prescribed time period (ST25: YES) or when the processor 110 of the management server 100 determines in ST30 that the consumption rate of the consumable is equal to or faster than the prescribed rate (ST30: YES), then in ST38 the processor 110 of the management server 100 internally sets the delivery mode to the non-delivery mode and sets related parameters to values for the non-delivery mode. At this time, in the user database, the processor 110 updates the delivery mode information associated with both the current user and the target consumable. More specifically, when the delivery mode information indicates that the delivery mode is the automatic delivery mode, in ST38 the processor 110 updates the delivery mode information so that the delivery mode information indicates that the delivery mode is the non-delivery mode (i.e., in ST38 the processor 110 changes the delivery mode from the automatic delivery mode to the non-delivery mode). However, when the delivery mode information indicates that the delivery mode is the non-delivery mode, in ST38 the processor 110 retains the delivery mode information so that the delivery mode information continues to indicate that the delivery mode is the non-delivery mode (i.e., in ST38 the processor 110 maintains the delivery mode in the non-delivery mode). Subsequently in ST40 the processor 110 of the management server 100 generates a new voucher QR code and issues this QR code to the mobile terminal 300.

In ST45 the user displays the voucher QR code on the mobile terminal 300 and presents this QR code to an employee at the retail store 600. In ST50 the employee reads the QR code with a register terminal and the register terminal confirms the validity of the voucher QR code with the management server 100. When validity is confirmed, in ST55 the processor 110 of the management server 100 returns a notification to the register terminal indicating that the voucher QR code is valid. Upon receiving this notification, in ST60 the register terminal performs an accounting process allowing the user to exchange the voucher for the consumable free of charge. Thereafter, in ST65 the processor 110 of the management server 100 performs a process to invalidate the voucher QR code and in ST70 issues a notification to the delivery center 500 requesting the delivery center 500 to deliver the consumable to the retail store 600 for replenishment. Subsequently, the sequence in FIG. 6 ends.

The processes in ST25 and ST30 are each an example of the determining whether a prescribed condition for changing the provision state is met. The processes in ST33 and ST38 are each an example of the changing the provision state.

### <Effects of the Embodiment>

As described above, the management server 100 provided in the printing service provision system 1 of the present embodiment stores the delivery mode in the user database indicating one of at least two modes including the automatic delivery mode and the non-delivery mode. The automatic delivery mode is a state in which a new consumable is delivered to the user when the residual quantity of the consumable currently in use under the prepaid printing service falls below the predetermined residual quantity. The non-delivery mode is a state in which procurement request information is outputted to the user when the residual quantity of the consumable currently in use under the prepaid printing service falls below the predetermined residual quantity. The procurement request information is information for requesting the user to obtain a new consumable through other means than delivery.

By performing the determinations in ST25 and ST30, the processor 110 determines whether a prescribed condition for changing the delivery mode have been met and changes the delivery mode when determining that the prescribed condition is met. As a result, the delivery mode can be changed to a mode convenient for the user or manufacturer.

For example, users must register an address and other personal information when having consumables delivered in the automatic delivery mode, but this is an inconvenience for users who do not wish to divulge their personal information. Changing the delivery mode to the non-delivery mode in such cases allows the user to obtain consumables using a voucher QR code rather than through delivery, thereby improving convenience for the user.

Further, for example, the time and cost required for the manufacturer to deliver consumables may be significant due to the user living in a remote location or other circumstances. Changing the delivery mode to the non-delivery mode in such cases enables the user obtain consumables themselves through other means than delivery. Therefore, the need for the manufacturer to ship the consumables can be eliminated, thereby improving convenience for the manufacturer.

The embodiment described above enables the user to obtain consumables in a manner that does not require delivery by changing the delivery mode to the non-delivery mode to suit the convenience of the user or manufacturer as described above, thereby improving convenience for the user or manufacturer.

A particular feature of this embodiment is that the information requesting users to obtain consumables themselves is in the form of a voucher QR code that is exchangeable for a new consumable. This enables the user to easily obtain a new consumable simply by presenting the voucher QR code at the retail store 600 or the like and exchanging the voucher for that new consumable.

Another feature of the present embodiment is that in the automatic delivery mode a new consumable is delivered to the user in response to the residual quantity of the consumable dropping below the predetermined residual quantity. However, the required delivery time period, i.e., the time period required for a consumable to reach the user after the consumable is shipped from the manufacturer, may be long due to the user's residence being in a remote location or other circumstances. In such cases, the management server 100 in the present embodiment determines in ST25 of FIG. 6 that the required delivery time period is greater than or equal to the prescribed time period, i.e., that the prescribed condition is met. Thus, the delivery mode can be changed from the automatic delivery mode to the non-delivery mode.

By changing the delivery mode to the non-delivery mode when predicting that much time is required to deliver a new consumable, the user can obtain a new consumable quickly without relying on shipment from the manufacturer.

While not illustrated in the drawings, the delivery cost may also be used as a prescribed condition for changing the delivery mode because changing the delivery mode to the non-delivery mode for having the user purchase a consumable themselves can be more advantageous for the manufacturer when delivery costs are likely to be high. Also, if the number of consumables to be delivered is large, it may be advantageous for the manufacturer to change the delivery mode to the non-delivery mode and have the user purchase the consumables themselves since the labor and cost for such delivery is high. Therefore, the number of consumables to be delivered may be used as a prescribed condition for changing the delivery mode.

Another feature of the present embodiment is that in the automatic delivery mode a new consumable is delivered to the user in response to the residual quantity of the consumable falling below the predetermined residual quantity. However, the consumable currently in use may become completely depleted before the new consumable shipped from the manufacturer reaches the user due to such reasons as the rate at which the user consumes the current consumable being faster than the prescribed rate anticipated by the manufacturer. In such cases, the management server 100 of the present embodiment can change the delivery mode from the automatic delivery mode to the non-delivery mode since the management server 100 determines in ST30 that the consumption rate is equal to or faster than the prescribed rate, i.e., that the prescribed condition is met.

When the management server 100 of the present embodiment predicts that a new consumable cannot be delivered in time owing to the user's usage status, the management server 100 can change the delivery mode to the non-delivery mode, enabling the user to acquire a new consumable quickly without waiting for a consumable to be shipped from the manufacturer.

Another feature of the present embodiment is that the management server 100 switches the delivery mode from the automatic delivery mode to the non-delivery mode in ST38 when the management server 100 receives a request to change the delivery mode through a suitable operation performed by the user. Thus, users can switch the method by which consumables are provided to suit their own convenience.

In the automatic delivery mode, for example, a new consumable is delivered to the user in response to the residual quantity of the consumable dropping below the predetermined residual quantity. Here, users must register an address and other personal information when having consumables delivered, but this is an inconvenience for users who do not wish to divulge their personal information. In such cases, the user can perform their own operations to change the delivery mode to the non-delivery mode, enabling the user to obtain consumables without relying on shipments from the manufacturer. Thus, this embodiment can improve convenience for the user.

### <Variations of the Embodiment>

While the invention has been described in conjunction with the example structure outlined above and illustrated in the figures, various alternatives, modifications, variations, improvements, and/or substantial equivalents, whether known or that may be presently unforeseen, may become apparent to those having at least ordinary skill in the art. Accordingly, the example embodiment of the disclosure, as set forth above, is intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below, wherein like parts and components to those in the above embodiment are designated with the same reference numerals to avoid duplicating description.

(1) A configuration of returning profits equivalent to the purchase costs and delivery fees for consumables to the user

In the above embodiment, a voucher QR code that can be exchanged for a consumable free of charge is issued when the user is required to obtain consumables themselves in the non-delivery mode in order to avoid charging the user twice for consumable-related costs already included in the prepaid fee, but the present disclosure is not limited to this configuration. As an alternative, when the user obtains a consumable by paying the purchase price at a retail store under the non-delivery mode, the manufacturer may return a profit to the user equivalent to the purchase price and delivery fee for the consumable after the fact.

For example, the management server 100 may perform a printable page increasing process to increase the number of printable pages by a guaranteed number of printable pages immediately after a consumable is purchased or may perform a printable page increasing process to increase the number of printable pages by the guaranteed number of printable pages either free of charge or at a discount at the next billing. Here, the guaranteed number of printable pages is a number of printable pages equivalent to a total profit of a first profit and a second profit. The first profit is a profit corresponding to the purchase price at which the user purchased the consumable, and the second profit is a profit corresponding to the delivery fee for that consumable, for example. When a configuration is employed in which the number of printable pages is increased by the guaranteed number of printable pages immediately after a consumable is purchased, the processor 110 of the management server 100 may execute steps ST80-ST95 in the sequence chart of FIG. 7, in place of steps ST40-ST70 for the non-delivery mode in the corresponding sequence chart of FIG. 6. That is, in ST80 the processor 110 of the management server 100 transmits purchase request information to the mobile terminal 300, encouraging the user to purchase the consumable themselves. After the actual purchase has been confirmed, in ST85 the processor 110 of the management server 100 increases the number of printable pages in the user database by an amount equivalent to the total of the purchase price and the delivery fee. In ST90 and ST95 the processor 110 of the management server 100 transmits commands to the respective mobile terminal 300 and printer 200 to increase the number of printable pages by the same amount. The process from ST85 to ST95 is an example of the granting the user a first benefit and is also an example of the granting the user a second benefit. The process to increase the number of printable pages by the amount equivalent to the total of the purchase price and the delivery fee is an example of the granting the user a process authorization.

Thus, when the delivery mode is switched to the non-delivery mode in this variation, the management server 100 requests users to purchase consumables themselves by transmitting purchase request information to the users encouraging them to purchase the consumables themselves. When a user agrees to purchase a consumable, in ST85-ST95 the management server 100 returns to the user the first profit corresponding to the purchase price of the new consumable in order to compensate the user for the purchase. In other words, in ST85-ST95 the management server 100 grants a first benefit corresponding to the purchase price of the new consumable in order to compensate the user for the purchase.

This variation is advantageous for the manufacturer because consumables no longer need to be delivered to the user and is advantageous for the user because the user can obtain consumables at a desired store while being compensated for the purchase price so as not to incur any loss to him or herself.

A particular feature of this variation is that the user can gain an increase in the number of printable pages on the printer 200 of an amount equivalent to the purchase price of the consumable. Thus, this variation can reliably offset at least the purchase price that the user pays for purchasing consumables.

Another feature of this variation is that, according to the service contact, the number of printable pages is set for the printer 200 based on the fee the user prepaids. Further, when the user purchases a new consumable himself or herself, the management server 100 grants the user a process authorization on the printer 200 corresponding to the purchase price of the new consumable. In this variation, the granting of the process authorization is executed by increasing the number of printable pages for the printer 200. Thus, this variation can offset the price paid by the user when purchasing a consumable with an increase in the number of printable pages for the printer 200.

Another feature of this variation is that when the delivery mode is switched to the non-delivery mode and the user obtains consumables themselves, in ST85-ST95 the management server 100 returns to the user the second profit corresponding to the delivery fee required for delivering the new consumable to the user, i.e., grants the user a second benefit corresponding to the delivery fee required for delivering the new consumable to the user, in order to return the amount of profit that the manufacturer gains by eliminating delivery of the consumable to the user.

This variation is advantageous for the manufacturer by eliminating the need for delivery and is advantageous for the user by enabling the user to acquire consumables at a desired store and by returning the profit margin the manufacturer receives for the elimination of delivery costs, which can give the user a sense of satisfaction rather than one of unfairness.

Another feature of this variation is that the user gains an increase in the number of printable pages for the printer 200 of an amount equivalent to the delivery fee for the consumable. Thus, the portion of the manufacturer's profits corresponding to the eliminated requirement for delivery can be reliably returned to the user.

Another feature of this variation is that, according to the service contact, the number of printable pages is set for the printer 200 based on the fee the user prepaids. Further, when the user purchases a new consumable himself or herself, the management server 100 grants the user a process authorization on the printer 200 corresponding to the delivery fee for the new consumable. In this variation, the granting of the process authorization is executed by increasing the number of printable pages for the printer 200. Thus, in this variation, the amount equivalent to the profit to be returned from the manufacturer corresponding to the delivery fee can be applied to an increase in the number of printable pages for the printer 200.

Instead of increasing the number of printable pages on the printer 200, the total profit corresponding to the purchase price and delivery fee for the consumable can be returned to the user via the transaction server 400 as a direct refund, i.e., a cash refund. In other words, instead of increasing the number of printable pages on the printer 200, the management server 100 may grant the user a benefit corresponding to the total amount of the purchase price and delivery fee for the consumable via the transaction server 400 as a direct refund, i.e., a cash refund.

The sequence charts shown in FIGS. 6 and 7 in the above description do not limit the present disclosure to the steps indicated therein. Steps may be added or deleted, or their order may be rearranged, without departing from the spirit and technical ideas of the present disclosure.

In addition to what has already been described, the methods according to the embodiment and its variations described above may be used in suitable combinations.

In addition, although not illustrated individually, the present disclosure may be implemented with various modifications without departing from the spirit of the present disclosure.

What is claimed is:

1. An information processing apparatus for managing a contract for a service to provide a consumable to a user, the information processing apparatus comprising:
a memory for storing therein provision state information indicating a provision state of the service, the provision state being one of at least two states including:
a first state in which when a residual quantity of a consumable in use under the service has dropped below a predetermined residual quantity, a new consumable is delivered to the user; and
a second state in which procurement request information is outputted to the user when the residual quantity of the consumable in use under the service has dropped below the predetermined residual quantity, the procurement request information requesting the user to obtain a new consumable in a manner not reliant on delivery; and
a controller configured to perform:
determining whether a prescribed condition for changing the provision state is met; and
changing the provision state when determining that the prescribed condition is met.

2. The information processing apparatus according to claim 1,
wherein the procurement request information is a voucher exchangeable for a new consumable.

3. The information processing apparatus according to claim 1,
wherein the procurement request information is a purchase request notification requesting the user to purchase a new consumable, and
wherein the controller is configured to further perform:
granting the user a first benefit in response to the user purchasing a new consumable, the first benefit being a benefit corresponding to a purchase cost of the new consumable purchased by the user.

4. The information processing apparatus according to claim 3,
wherein the granting the user the first benefit is executed by:
giving the user a refund of an amount equivalent to the purchase cost; or
granting the user a process authorization corresponding to the purchase cost, the process authorization being an authorization to perform a process using a prescribed process apparatus.

5. The information processing apparatus according to claim 4,
wherein the prescribed process apparatus is a printing apparatus for which a printable quantity based on a fee paid by the user is set according to the contract of the service, and
wherein the granting the user the process authorization is executed by increasing the printable quantity either free of charge or at a discount.

6. The information processing apparatus according to claim 1,
wherein the controller is configured to further perform:
granting the user a second benefit when the user has obtained a new consumable in a state where the provision state information stored in the memory indicates the provision state is the second state, the second benefit being a benefit equivalent to a delivery cost required for delivering the obtained new consumable to the user.

7. The information processing apparatus according to claim 6,
wherein the granting the user the second benefit is executed by:
giving the user a refund of an amount corresponding to the delivery cost; or granting the user a process authorization corresponding to the delivery cost, the process authorization being an authorization to perform a process using a prescribed process apparatus.

8. The information processing apparatus according to claim 7,
wherein the prescribed process apparatus is a printing apparatus for which a printable quantity based on a fee paid by the user is set according to the contract of the service, and
wherein the granting the user the process authorization is executed by increasing the printable quantity either free of charge or at a discount.

9. The information processing apparatus according to claim 1,
wherein the determining includes:
determining, after the residual quantity of the consumable has dropped below the predetermined residual quantity, whether a required delivery time period exceeds a predetermined time period, the required delivery time period being a time period required for a new consumable to be delivered to the user, and
wherein, when determining that the required delivery time period exceeds the predetermined time period,
the determining whether the prescribed condition is met determines that the prescribed condition is met, and
the changing changes, when the provision state information stored in the memory indicates that the provision state is the first state, the provision state from the first state to the second state.

10. The information processing apparatus according to claim 1,
wherein the determining includes:
determining, after the residual quantity of the consumable has dropped below the predetermined residual quantity, whether a consumable consumption rate exceeds a predetermined rate, the consumable consumption rate being a rate at which the consumable in use under the service is consumed, and
wherein, when determining that the consumable consumption rate exceeds the predetermined rate,
the determining whether the prescribed condition is met determines that the prescribed condition is met, and
the changing changes, when the provision state information stored in the memory indicates that the provision state is the first state, the provision state from the first state to the second state.

11. The information processing apparatus according to claim 1,
wherein, when receiving a change request in a state where the provision state information stored in the memory indicates that the provision state is the first state,
the determining determines that the prescribed condition is met, and
the changing changes the provision state from the first state to the second state, the change request being a request issued based on an operation performed by the user to request to change the provision state.
